(19) United States
(12) Patent Application Publication
(10) Pub. No.: US 2018/0304188 A1
(43) Pub. Date: Oct. 25, 2018

(54) Outdoor Air Filtration Device

(71) Applicant: Carl Phelps, JR., Monroe, LA (US)

(72) Inventor: Carl Phelps, JR., Monroe, LA (US)

(21) Appl. No.: 15/495,125

(22) Filed: Apr. 24, 2017

(51) Int. Cl. B01D 46/42; B01D 46/00; B01D 46/10

(52) U.S. Cl. CPC B01D 46/4245; B01D 46/4236; B01D 46/10; B01D 46/0041

(57) ABSTRACT

The current invention are air filtration devices for outdoor use. The filtration systems would be installed on residential, commercial, and industrial buildings. They would be placed on a large amount of buildings to improve air quality over a large area. As the devices will be installed on regularly used buildings, they have a double casing that dampens noise. The filters will remove fine particulates and many problematic air pollutants. The entire system is powered by a low consumption battery.

### CROSS-REFERENCES TO RELATED APPLICATIONS (IF ANY)

None.

### BACKGROUND

### 1. Field of the Invention

This invention relates to air purifiers and particularly ones for outdoor use.

### 2. Description of Prior Art

Air pollution is a problem around the world. Many activities generate air pollution, such as energy or factory production emission, car exhaust, and agricultural activities. Pollutants can be specific chemicals, such as carbon monoxide, or as fine particles that can agitate your respiratory system. Air pollution is linked with increased rates of developing respiratory problems like asthma. While there are many air purifiers available for indoor use and dust masks are commonly worn in highly polluted areas, there aren't residential systems to help improve air quality.

There is still room for improvement in the art.

### SUMMARY OF THE INVENTION

The current invention is an outdoor air purifier system which is composed of air filters, fan, casing, and power source.

The system has a double walled casing. The casing is made of durable material, such as hard plastics or metals. The double walled casing protects the filtration system and acts as a noise dampener.

The power source is a low-consumption battery, so it doesn't require an external power source. The battery can be replaced or recharged. The air intake would move air through the filter and would

### BRIEF DESCRIPTION OF THE DRAWINGS

Without restricting the full scope of this invention, the preferred form of this invention is illustrated in the following drawings:

FIG. 1 is a front side view of the unit;

FIG. 2 is another front side view of the unit;

FIG. 3 is a back side view of the unit;

FIG. 4 shows the double wall casing;

FIG. 5 shows the filter intake;

FIG. 6 shows the bottom of the unit; and

FIG. 7 is a rendering of the unit on a house.

### DESCRIPTION OF THE PREFERRED EMBODIMENT

There are a number of significant design features and improvements incorporated within the invention.

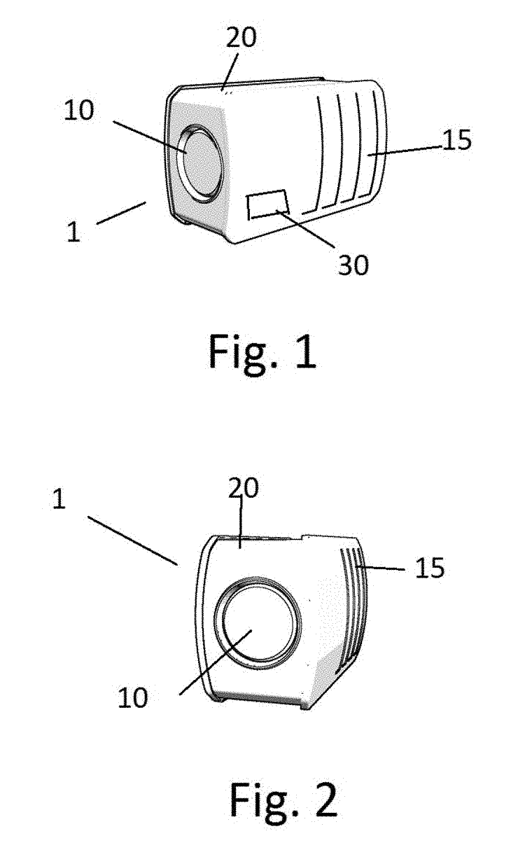

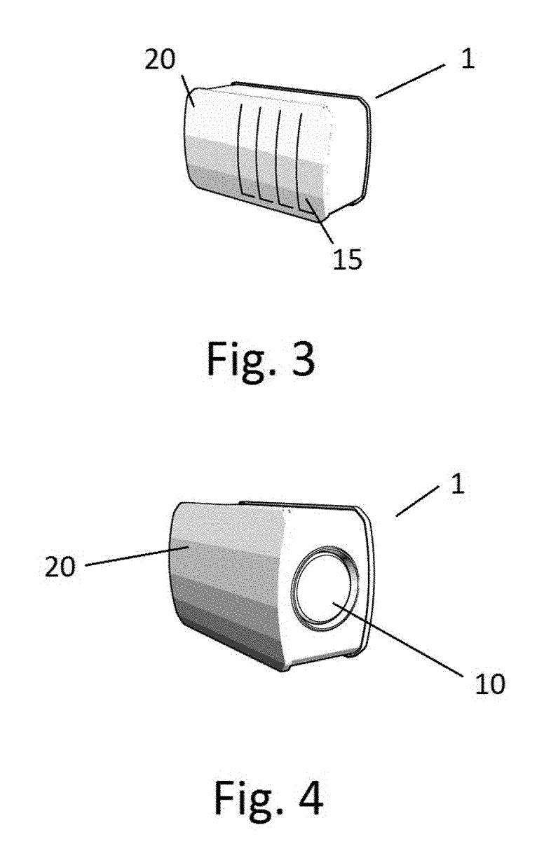

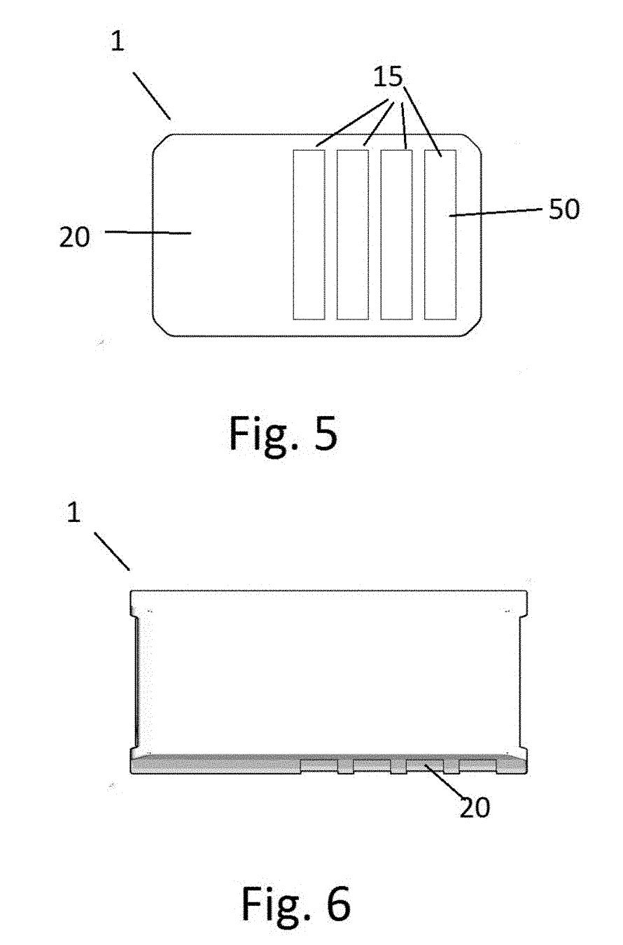

As shown in FIGS. 1 through 7, the current invention is an outdoor air purifier system unit 1 which is composed of air filters 50, a fan 40, casing 20, and power source 30.

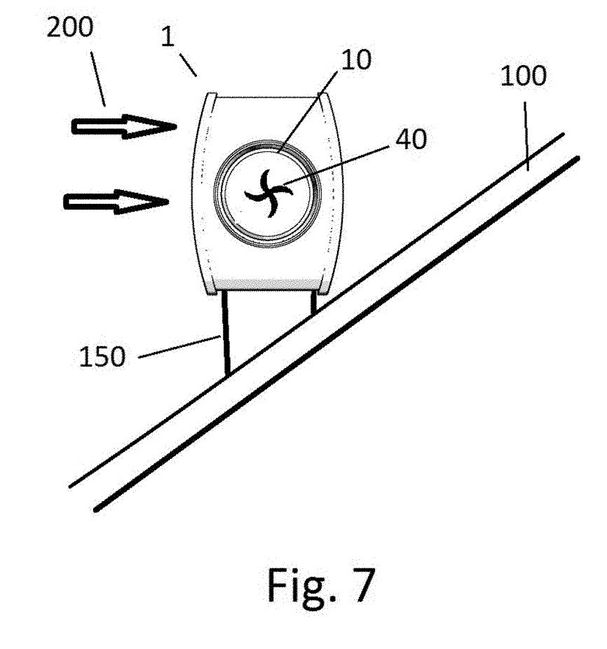

The unit 1 is rectangular in shape with filter air intake slots 15 in one of the sides that pulls the air from the outside and through the filter 10 as shown in FIG. 7. The air 200 then flows out the air out flow vent 10. The other side is a solid double casing for sound proofing. The fan 40 will drive the air through the unit 1 and is located within the casing 20.

The unit 1 has a double walled casing 20. The casing 20 is made of durable material, such as hard plastics or metals. The double walled casing protects the filtration system and acts as a noise dampener.

The power source 30 is a low-consumption battery, so it doesn't require an external power source. The battery can be replaced or recharged. The air intake would move air through the filter 50 and would purify the air 200.

The unit 1 uses standard air filters 50.

The unit 1 purifies by removing smog and releasing clean, breathable air, silent due to the double wall casing and unique design suppresses noise, effective s it removes allergens, pollutants and airborne chemicals and continuous as the low consumption battery means the unit 1 can always be on.

As shown in FIG. 7, the unit 1 is fixed to a roof 100 using roofing brackets 150. The air 200 goes in the filter air intake slots 15 in the side of the casing 20 flows through the filters 50 and out the out the air out flow vent 10 into the home.

### Advantages

The innovative filtration system would provide a method for improving outdoor air quality, without large, unsightly and loud infrastructure or devices. While indoor filtration helps, outdoor air pollution reduces human health and enjoyment of the outdoors. This filtration system would allow for constant filtration of outdoor air and can be turned off or reduced when air quality goals are met. The system would be of the greatest benefit in areas that have minimal air flow, such as in mountain valleys, where pollutants can be trapped.

Although the present invention has been described in considerable detail with reference to certain preferred versions thereof, other versions are possible such as different tension means, bobber shapes and sizes and different colored lights. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. An outdoor air purifier system unit comprising;
A casing with a double wall structure with air intake vents on one side with air filters inside where the air flows into the air intake slots through the filters and out the out flow vents where the air flow is driven by a fan.

2. An outdoor air purifier system unit of claim 1 further comprising;
Have a power source.

3. An outdoor air purifier system unit of claim 2 further comprising;
Where the power source is a low-consumption battery.

4. 2. An outdoor air purifier system unit of claim 1 further comprising;
Where the case is rectangular in shape.
